(19) United States
(12) Patent Application Publication
(10) Pub. No.: US 2012/0079152 A1
(43) Pub. Date: Mar. 29, 2012

(54) METHOD FOR CONNECTING SLAVE CARDS TO A BUS SYSTEM

(76) Inventor: Paul Mohr, Weinstadt-Beutelsbach (DE)

(21) Appl. No.: 13/259,844

(22) PCT Filed: Apr. 8, 2010
(86) PCT No.: PCT/EP10/54625

§ 371 Date: Dec. 13, 2011

(30) Foreign Application Priority Data
Apr. 8, 2009 (DE) 10 2009 002 281.3

(51) Int. Cl. G06F 13/00

(52) U.S. Cl. 710/110

(57) ABSTRACT

A method for connecting slave cards to a first bus system and a system for implementing the method are described. In the method, signals are transferred from the slave cards to a CPU via the first bus system, a master being assigned to each slave card, and the signals being transferred from each slave card via the assigned master.

### FIELD OF THE INVENTION

The present invention relates to a method for connecting slave cards to a bus system, a system for implementing the method and a computer program and a computer program product.

### BACKGROUND INFORMATION

For the transfer of signals in transfer systems, participants in this system are as a rule broken down into slaves and normally one master according to a predefined hierarchy. The term master/slave thus denotes one form of hierarchical management.

U.S. Pat. No. 6,189,061 B1 discusses, for example, a multi-master bus system having one bus and a plurality of bus devices which are coupled to the bus. A memory control for controlling the data exchange via the bus and one allocator for performing a bus allocation are also provided.

In many applications, the slaves are connected to the master via a VME bus (VME: Versa Module Eurocard). This denotes a multi-user bus which is used in particular in process control. The VME bus is distinguished in that one VME master communicates with multiple VME slaves. The VME master may then forward the signals or data of the slaves to a higher level CPU.

VME bus systems are used in many systems for connecting signal input and output cards with a higher level CPU. In doing so, the VME master communicates sequentially with the VME slaves. In this connection, the bus communication is configured to be asynchronous. This means that the signals or data are sent using a handshake method. In some cases, the CPU of the VME master takes over functions including monitoring and control. However, it is frequently the case that the VME master is used as a connecting link between the VME slaves and a higher level CPU.

Disadvantages of the known method are the low data transfer rate, the high latency time and the migration capability of VME slave cards located in the field.

The sequential communication between the VME master and VME slave limits the volume of data that can be communicated via the VME bus. This causes the low data transfer rate which does not take into account the present market requirements, since significantly higher data transfer rates are needed.

From the perspective of a higher level CPU, the latency time is very high for sending information to the VME slave or receiving information from the VME slave. In this point as well, the market requirements significantly exceed the possible performance of a serial VME master/slave communication.

The VXS standard represents a serial switching concept for the VME bus. It should be noted that the VXS standard (VXS: VME extension for serial switching) requires a new printed conductor configuration and accordingly a considerable modification of production to eliminate the mentioned disadvantages. It is thus not possible to improve VME slaves existing in the field with respect to data transfer rate and latency time.

### SUMMARY OF THE INVENTION

The VXS.4 standard which connects VME with PCI Express was developed to avoid the mentioned disadvantages. In this connection, another plug connector is attached to a VME board and the fast serial signals such as PCI Express are transferred via it.

The described method is used for connecting slave cards to a first bus system in which signals from the slave cards are transferred to a CPU via the first bus system, a master being assigned to each slave and the signals being transferred from each slave card in particular via a second bus system via the assigned master.

The described method thus provides that slave cards located in the field such as, for example, VME slaves may be improved by a parallelization of the communication with regard to data transfer rate and latency time.

In this connection, a master is assigned to each slave. Consequently, a point-to-point connection is established between masters and slaves.

In one embodiment of the method, a PCI Express bus system is used as the first bus system. PCI Express (Peripheral Component Interconnect Express: PCIe) is an extension standard for connecting peripheral devices to the chip set of a CPU.

Furthermore, it may be provided that the signals are transferred from the slave cards to the particular masters via a second bus system. A VME bus system is typically used as the second bus system.

In one embodiment, the signals of the slave cards are routed to an FPGA (Field Programmable Gate Array) in which the masters are implemented. It is also possible to connect multiple slaves, typically VME slaves, to an FPGA. In the FPGA, a number of master instances (typically VME master instances) is set up which is equal to the number of connected slaves (VME slaves). The data from the VME masters may then be transferred to the PCI Express bus in the FPGA. Since the data transfer takes place within the FPGA, it may be configured optimally and efficiently.

Another embodiment provides that the first bus system has multiple nodes and signals are transferred from the multiple nodes to a central switch. A cascading is performed in this way. The described electronic system for connecting slave cards to a first bus system is used in particular for implementing a method of the above-described type and is configured for transferring signals from the slave cards to a CPU via the first bus system, a master being assigned to each slave and the signals being transferred from each slave card via the assigned master.

A PCI Express bus system is used, for example, as the first bus system. The signals from the slave cards are regularly transferred to the particular masters via a second bus system such as, for example, a VME bus system.

In this embodiment, the masters are implemented in an FPGA. In this case, the signals of the slaves are routed to the FPGA.

The described computer program includes program code for performing all steps of a method described above if the computer program is run on a computer or a corresponding arithmetic unit, in particular in a described system.

The computer program product has this program code which is stored on a computer-readable data medium.

At least in some of the embodiments, the exemplary embodiments and/or exemplary methods of the present invention thus provide for communicating data between VME slaves to a higher level CPU in a parallel manner. In this connection, a separate VME master is assigned to each VME slave. The data from the VME masters may then be transferred to the higher level CPU via PCI Express signals. In this connection, the VME master is used as a connecting link between the VME slaves and a higher level CPU.

Additional advantages and embodiments of the present invention may be found in the description and the accompanying drawings. Of course, the features referred to above and the features still to be explained below are usable not only in the particular combination specified but also in other combinations or alone without departing from the framework of the present invention.

### BRIEF DESCRIPTION OF THE DRAWINGS

FIG. 1 shows a conventional VME bus structure in a schematic representation.

FIG. 2 shows the connection of slave cards according to one embodiment of the present invention in a schematic representation,

FIG. 3 shows the structure of a back plate for VME slaves in a schematic representation.

FIG. 4 shows VXS printed boards in a perspective view.

### DETAILED DESCRIPTION

The exemplary embodiments and/or exemplary methods of the present invention are depicted schematically in the drawings based on specific embodiments and will be described in greater detail below with reference to the drawings.

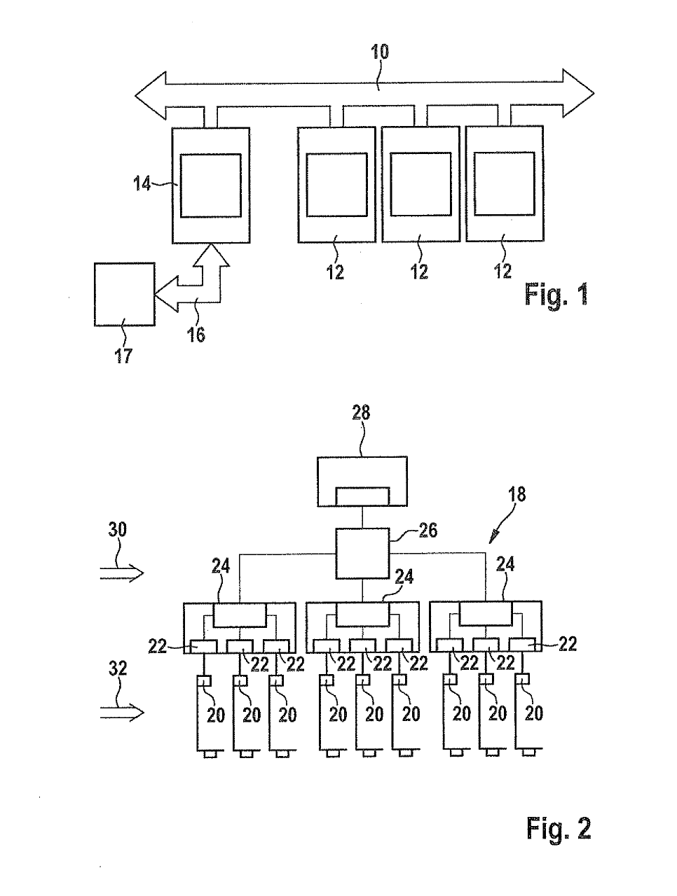

A conventional VME bus structure is rendered in FIG. 1. The representation shows a VME bus 10 to which a series of VME slave cards 12 are connected. Furthermore, VME bus 10 is coupled with a VME master 14. VME master 14 represents the bridge between VME bus 10 and an additional bus 16, for example, Ethernet. VME master 14 is connected to a CPU 17 via this additional bus 16.

The disadvantages of the represented conventional structure are the low data transfer rate, the high latency time and the migration capability of VME slave cards 12 located in the field.

FIG. 2 shows one embodiment of system 18 according to the present invention for elucidating the approach according to the present invention. The representation shows a number of slave cards 20, a master 22 being precisely unambiguously assigned to each of these slave cards 20. Furthermore, three nodes 24, in this case PCI Express nodes, are apparent, each of them being assigned to three masters 22. These nodes 24 are in turn connected to a central switch 26, which in this case is configured as a PCI Express switch. Switch 26 forwards the signals to a CPU 28.

Represented system 18 includes two bus systems, namely, a first bus system 30, in this case a PCI Express bus system, and a second bus system 32, in this case a VME bus system. Second bus system 32 connects slave cards 20 to the assigned masters 22. First bus system 30 connects masters 22 to CPU 28 via nodes 24 and switch 26. Masters 22 represent a bridge between first bus system 30 and second bus system 32. Furthermore, the cascading of first bus system 30, including multiple nodes 24 and a switch 26, is apparent.

FIG. 2 clearly shows that a master 22 is assigned to each slave card 20. Point-to-point communication is thus implemented between slaves 20 and masters 22. Parallelization of the communication significantly improves system 18 with respect to the data transfer rate and the latency time compared to known systems.

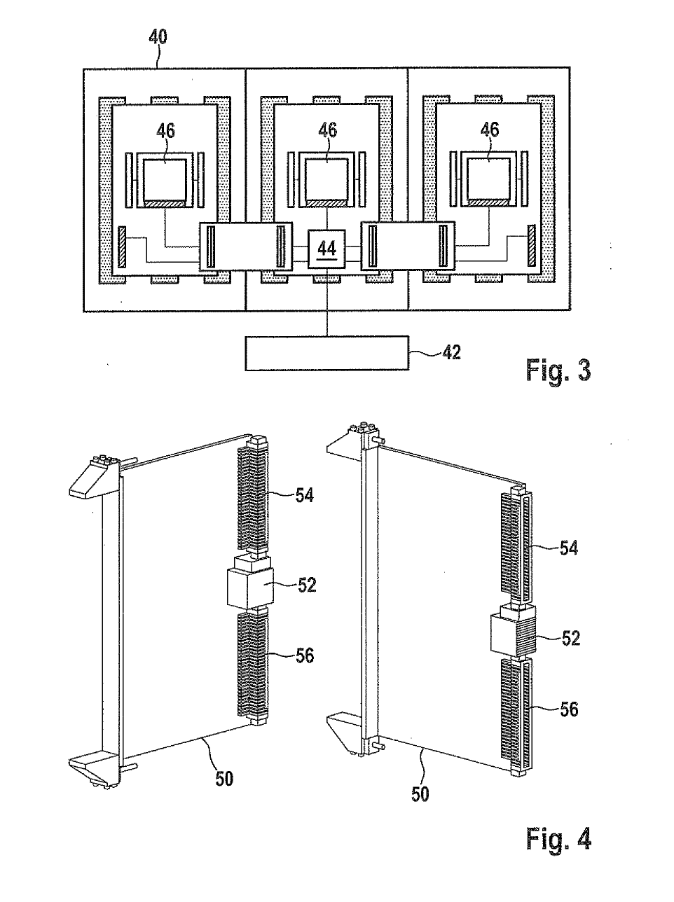

FIG. 3 shows a possible structure of a back plate or back plane 40 for VME slaves in a schematic representation. The representation shows a CPU 42, a PCI Express switch 44 and three FPGAs 46. In this embodiment, the VME slaves are connected to one VME master-FPGA each, i.e., the masters are implemented in the shown FPGAs 46. FPGAs 46 are placed on the back of back plate 40. The signals from three VME slave cards are routed to one of FPGAs 46 in each case. The PCI Express signals of individual FPGAs 46 are routed to central PCI Express switch 44. This switch 44 is in turn connected to the higher level CPU.

Two views of a VXS printed board or a VXS board 50 are depicted in FIG. 4. Printed board 50 has three plug connectors, specifically plug connectors P0 (reference numeral 52), plug connector P1 (reference numeral 54) and plug connector P2 (reference numeral 56). Plug connectors P1 54 and P2 56 are provided for the connection to the VME bus and plug connector P0 52 is provided for the fast serial signals such as, for example, PCI Express. The new standard is primarily usable for VME cards having six height units. Space for plug connector P0 52 is, if necessary, not present in cards having three height units. This plug connector P0 52 is, however, not needed in the present invention. The signals of the VME slave cards are routed via present VME plug connectors P1 54 and P2 56.

1-10. (canceled)

11. A method for connecting slave cards to a first bus system, the method comprising:
transferring signals from the slave cards to a processor via the first bus system;
assigning a master to each of the slave cards; and
transferring the signals from each of the slave cards via a second bus system via the assigned master.

12. The method of claim 11, wherein the first bus system includes a PCI Express bus system.

13. The method of claim 11, wherein the signals are transferred from the slave cards to the particular masters via a second bus system.

14. The method of claim 13, wherein the second bus system includes a VME bus system.

15. The method of claim 11, wherein the signals of the slave cards are routed on an Field Programmable Gate Array (FPGA) in which the masters are implemented.

16. The method of claim 11, wherein the first bus system has multiple nodes, and wherein signals from the multiple nodes are transferred to a central switch.

17. An electronic system for connecting slave cards to a first bus system, comprising:
a transferring arrangement to transfer signals from the slave cards to a processor via the first bus system;
an assigning arrangement to assign a master to each of the slave cards; and
another transferring arrangement to transfer the signals from each of the slave cards via a second bus system via the assigned master.

18. The electronic system of claim 17, wherein the master is implemented in a Field Programmable Gate Array (FPGA).

19. A computer-readable data medium having a computer program, which is executable by a processor, comprising:
a program code arrangement having program code for connecting slave cards to a first bus system, by performing the following:
transferring signals from the slave cards to a processor via the first bus system;
assigning a master to each of the slave cards; and
transferring the signals from each of the slave cards via a second bus system via the assigned master.

20. An electronic system for connecting slave cards to a first bus system, comprising:
a computer-readable data medium having a computer program, which is executable by a processor, including:
a program code arrangement having program code for connecting slave cards to a first bus system, by performing the following:
transferring signals from the slave cards to a processor via the first bus system;
assigning a master to each of the slave cards; and
transferring the signals from each of the slave cards via a second bus system via the assigned master.
